(19) United States
(12) Patent Application Publication
(10) Pub. No.: US 2024/0414783 A1
(43) Pub. Date: Dec. 12, 2024

(54) COMMUNICATION DEVICE, CONTROL METHOD THEREOF, AND MEDIUM

(71) Applicant: CANON KABUSHIKI KAISHA, Tokyo (JP)

(72) Inventor: Kazuo Moritomo, Kanagawa (JP)

(21) Appl. No.: 18/750,145

(22) Filed: Jun. 21, 2024

Related U.S. Application Data
(63) Continuation of application No. PCT/JP2022/047855, filed on Dec. 26, 2022.

(30) Foreign Application Priority Data
Feb. 18, 2022 (JP) 2022-024018

(51) Int. Cl. H04W 76/11; H04L 69/22; H04W 72/25

(52) U.S. Cl. CPC H04W 76/11; H04L 69/22; H04W 72/25

(57) ABSTRACT

A communication device mounted on a moving body, comprises: a first communication unit configured to receive a radio signal transmitted by a first wireless method; a second communication unit configured to perform wireless communication by a second wireless method. The communication device obtains an information element included in the radio signal received by the first communication unit; generates, by using the information element, a communication identifier to be used in the wireless communication by the second wireless method; adds the communication identifier to information concerning the moving body, and transmitting the information via the second communication unit; and receives a radio signal from an external device, to which the communication identifier is added, via the second communication unit.

### CROSS-REFERENCE TO RELATED APPLICATIONS

This application is a Continuation of International Patent Application No. PCT/JP2022/047855, filed Dec. 26, 2022, which claims the benefit of Japanese Patent Application No. 2022-024018 filed Feb. 18, 2022, both of which are hereby incorporated by reference herein in their entirety.

### BACKGROUND OF THE INVENTION

### Field of the Invention

The present invention relates to connection control of communication in wireless communication.

### BACKGROUND ART

In recent years, wireless communication standards such as LTE (Long Term Evolution) and NR (New Radio) have been formulated. Among these, a wireless communication specification called Sidelink communication between devices without interposing a mobile communication network (core network) is formulated. More specifically, this is direct wireless communication between devices using an interface called PC5. In Sidelink communication, an L2ID (Layer-2 ID) that is an identifier indicating a transmission source device or a transmission destination device is used. There has been provided a system that obtains information (a position, a speed, vehicle control information, and the like) of each vehicle on the periphery by performing Sidelink communication between vehicles and performs driving support as needed.

PTL 1 proposes a technique in which a server acquires the position information or speed information of a moving vehicle and creates map information that associates the current position of the vehicle and an L2ID assigned to the vehicle. There is also proposed a technique of performing communication between the vehicles using the L2ID based on the map information and exchanging information between vehicles.

### CITATION LIST

### Patent Literature

PTL 1: Japanese Patent Laid-Open No. 2021-015354

In PTL 1, however, since the L2ID is received from the server device via a public line, it is impossible to acquire the L2ID in a place without the public line. For this reason, desired information exchange between vehicles cannot be implemented under such circumstances.

The present invention has been made in consideration of the problem, and provides a technique of facilitating information exchange between vehicles.

### SUMMARY OF THE INVENTION

According to one aspect of the present invention, a communication device mounted on a moving body, comprises: a first communication unit configured to receive a radio signal transmitted by a first wireless method; a second communication unit configured to perform wireless communication by a second wireless method; an obtaining unit configured to obtain an information element included in the radio signal received by the first communication unit; a generation unit configured to generate, by using the information element, a communication identifier to be used in the wireless communication by the second wireless method; a transmission unit configured to add the communication identifier to information concerning the moving body, and transmitting the information via the second communication unit; and a reception unit configured to receive a radio signal from an external device, to which the communication identifier is added, via the second communication unit.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a view showing an example of the configuration of an inter-vehicle communication system.

FIG. 2 is a block diagram showing the functional configuration of a roadside machine.

FIG. 3 is a block diagram showing the functional configuration of an in-vehicle device.

FIG. 4 is a sequence chart showing an operation in the inter-vehicle communication system.

FIG. 5 is a flowchart for explaining processing in the in-vehicle device.

FIG. 6 is a view for explaining data transmission in Broadcast and Groupcast methods.

FIG. 7 is a view for explaining data transmission in a Unicast method.

FIG. 8 is a block diagram showing the hardware configuration of the roadside machine.

FIG. 9 is a view showing an example of an L2ID.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

A communication device according to the first embodiment of the present invention will be described below using an inter-vehicle communication system using a roadside machine as an example.

### System Configuration

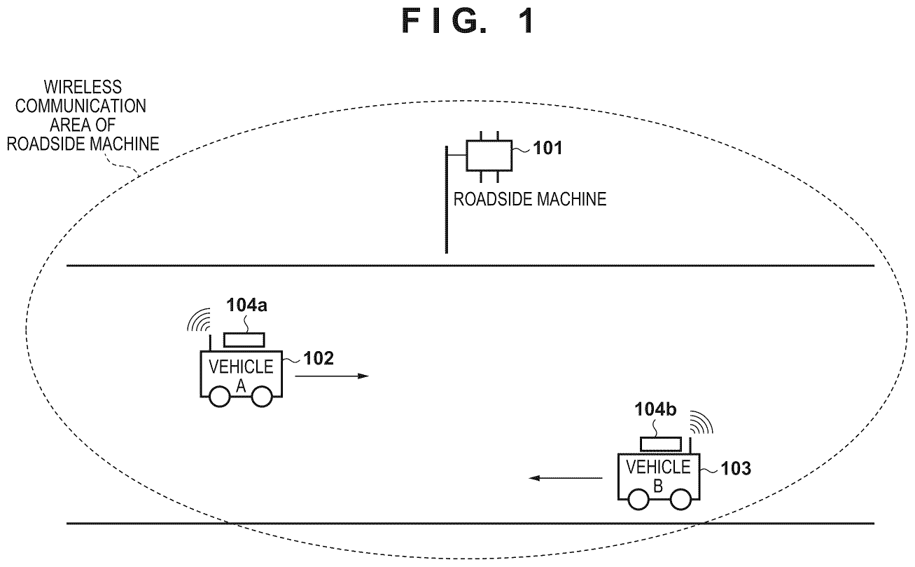

FIG. 1 is a view showing the configuration of an inter-vehicle communication system. This shows a situation in which vehicles 102 and 103 each provided with an in-vehicle device are traveling on a road with a roadside machine 101 installed on a side of the road.

The roadside machine 101 is a device that notifies, by wireless communication, the periphery of information detected by itself or information in a server on the Internet. The roadside machine 101 is a device that notifies another wireless device of information using a wireless communication method such as Wi-Fi, Bluetooth®, ETC, cellular (5G and LTE), or Sidelink. In FIG. 1, a wireless communication area (wireless connection possible range) by the roadside machine 101 is exemplarily indicated by a broken line.

The vehicles 102 and 103 are vehicles that are moving bodies traveling on the road. In-vehicle devices 104a and 104b (represented by an in-vehicle device 104 hereinafter) are in-vehicle devices mounted on the vehicles 102 and 103. The in-vehicle device 104 is a device that acquires information from the outside of the vehicle via wireless communication and displays it, or acquires information of the vehicle and shares the information with an external device via wireless communication. The in-vehicle device 104 acquires information from a sensor or a camera mounted on the vehicle as vehicle information and uses it. Also, the in-vehicle device 104 can also analyze traffic information from information obtained from the sensor mounted on the vehicle or information obtained by analyzing a camera video and transmit the information to another wireless device.

### Functional Configurations of Roadside Machine and In-Vehicle Device

The functional configurations of the roadside machine 101 and the in-vehicle device 104 will be described next. Note that the configuration of functional blocks to be described below is merely an example. Some (or in some cases, all) of the functional blocks to be described may be replaced with other functional blocks having the same functions, some functional blocks may be omitted, or functional blocks may further be added. One functional block shown in the following description may be divided into a plurality of functional blocks, or a plurality of functional blocks may be integrated into one functional block.

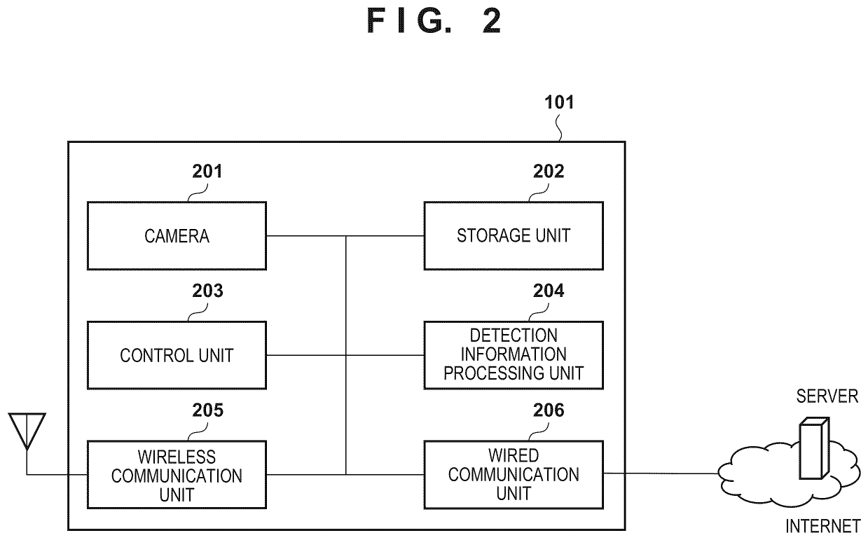

FIG. 2 is a block diagram showing the functional configuration of the roadside machine 101. A camera 201 ascertains the traffic situation of the road. A storage unit 202 stores a video from the camera 201 or information obtained by communication. A control unit 203 controls the operation of the roadside machine 101. A detection information processing unit 204 processes information obtained by the camera 201 or a sensor and judges the traffic situation. A wireless communication unit 205 transmits/receives information to/from an external wireless device. A wired communication unit 206 is connected to the Internet by wire and acquires information from another device such as a server.

In the roadside machine 101, an image captured by the camera 201 is processed by the detection information processing unit 204, and the wireless communication unit 205 notifies an external wireless device of the processing result. In addition, traffic information is acquired from an external server via the wired communication unit 206, the acquired information is processed by the detection information processing unit 204, and the wireless communication unit 205 transmits the information to an external wireless device. The wireless communication unit 205 is configured to be able to perform communication in correspondence with one or a plurality of first wireless methods such as Wi-Fi, Bluetooth, ETC, cellular communication (5G and LTE), and an Sidelink communication in accordance with the installation place or the notification target device.

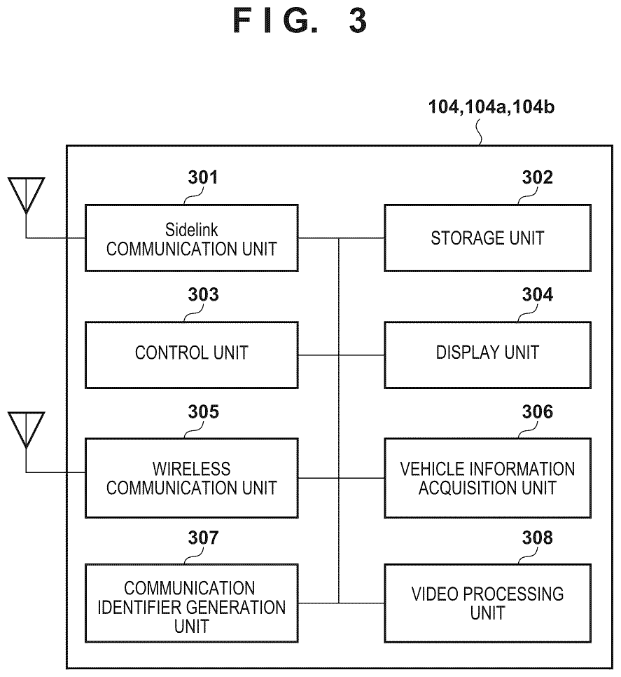

FIG. 3 is a block diagram showing the functional configuration of the in-vehicle device 104. A Sidelink communication unit 301 executes Sidelink communication that is a second wireless method using a designated L2ID. A storage unit 302 holds information necessary when the in-vehicle device 104 operates. A control unit 303 controls the operation of the in-vehicle device 104. A display unit 304 displays the state of the self-vehicle, the situation of another vehicle, traffic information, and the like. A wireless communication unit 305 performs wireless communication with an external device. A vehicle information acquisition unit 306 acquires information of the vehicle with the in-vehicle device 104 mounted. A communication identifier generation unit 307 generates an L2ID that is a communication identifier used by the Sidelink communication unit 301. A video processing unit 308 analyzes a video acquired from a camera mounted on the in-vehicle device 104 or an external camera and judges the traffic situation or the like.

In the in-vehicle device 104, the wireless communication unit 305 acquires information of a radio signal from the roadside machine 101 (that is, a radio signal of the first wireless method), and the communication identifier generation unit 307 generates an L2ID. The generated L2ID is notified to the Sidelink communication unit 301, and the Sidelink communication unit 301 operates to perform Sidelink communication (that is, transmission/reception of a radio signal of the second wireless method) with another device.

If information that should be notified to an external device occurs in the vehicle information acquisition unit 306, the communication identifier generation unit 307 generates an L2ID to which the information to be notified is added. In a case where information that should be notified to an external device occurs in the video processing unit 308 as well, similarly, the communication identifier generation unit 307 generates an L2ID to which the information to be notified is added.

FIG. 9 is a view showing an example of a 3-byte L2ID generated by the communication identifier generation unit 307. In the example shown in FIG. 9, a numerical value obtained by processing, by a hash function or the like, the identifier of wireless communication that the in-vehicle device 104 obtains from the roadside machine 101 is set to the value (0000 to FFFF in hexadecimal notation) of the upper two bytes (the second byte and the first byte) of the L2ID. Note that as the identifier of wireless communication, a network identifier (SSID) or a transmission source address (BSSID/MAC address) can be used. Also, a value according to the state information or the like of the device mounting vehicle, which is held by the in-vehicle device 104, is set to the value (00 to FF in hexadecimal notation) of the lower one byte (the 0th byte) of the L2ID. As the state of the vehicle, for example, information concerning the attribute of a vehicle such as an emergency vehicle or a failed vehicle, and information concerning the attribute of driving such as “scheduled to turn right” or “scheduled to join” can be used.

### Hardware Configuration of Roadside Machine/In-Vehicle Device

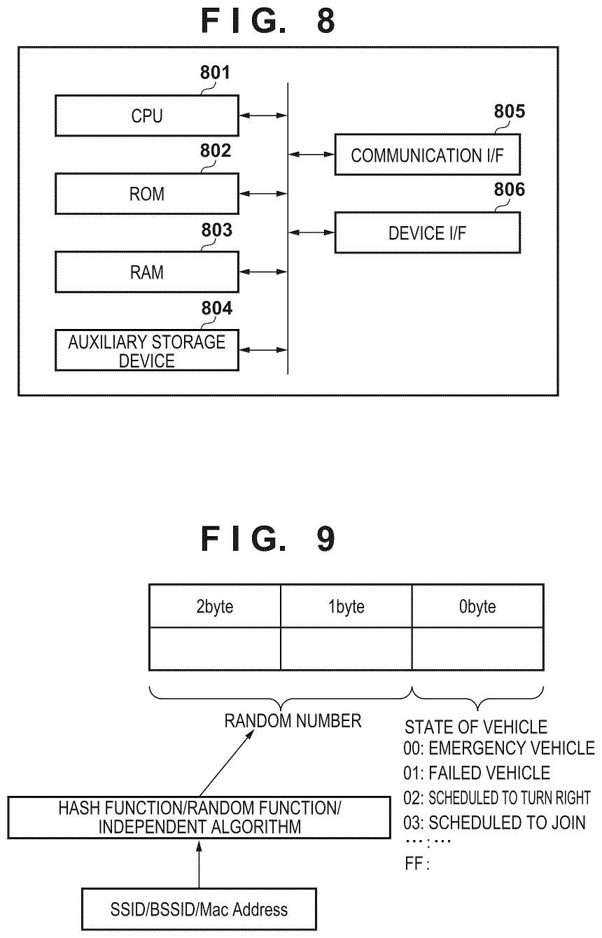

FIG. 8 is a block diagram showing the hardware configuration of the roadside machine 101. The roadside machine 101 includes a CPU 801, a ROM 802, a RAM 803, an auxiliary storage device 804, a communication I/F 805, a device I/F 806, and a bus.

The CPU 801 controls the whole roadside machine 101 using a computer program and data stored in the ROM 802 or the RAM 803, thereby implementing each function of the roadside machine 101 shown in FIG. 2. Note that the roadside machine 101 may have one or a plurality of pieces of dedicated hardware different from the CPU 801, and the dedicated hardware may execute at least a part of processing of the CPU 801. Examples of the dedicated hardware are an ASIC (Application Specific Integrated Circuit), an FPGA (Field Programmable Gate Array), and a DSP (digital signal processor).

The ROM 802 stores, for example, a program that need not be changed. The RAM 803 temporarily stores programs and data supplied from the auxiliary storage device 804 and data supplied from the outside via the communication I/F 805. The auxiliary storage device 804 is formed by, for example, a hard disk drive and stores various kinds of data.

The communication I/F 805 is used for communication with an external device. For example, the wireless communication unit 205 performs wireless communication with the in-vehicle device 104 that is an external device using the communication I/F 805. The device I/F 806 connects various kinds of devices. For example, a display device used by a manager to confirm information managed by the roadside machine 101 or a sensor or a camera mounted on the roadside machine 101 can be connected to the device I/F 806.

An example of the hardware configuration of the roadside machine 101 has been described above with reference to FIG. 8. The in-vehicle device 104 can also be implemented by the same hardware configuration. For example, if the in-vehicle device 104 has a hardware configuration as shown in FIG. 8, an image capturing unit including a mechanism configured to execute image capturing or a sensor of the vehicle can be connected to the device I/F 806.

### Operation of Device

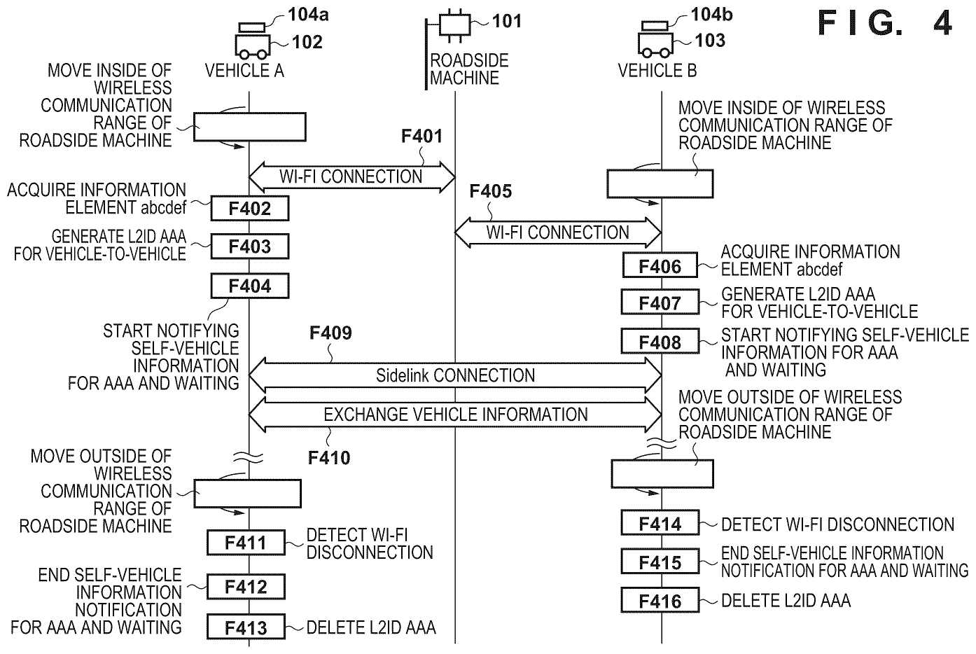

FIG. 4 is a sequence chart showing an operation in the inter-vehicle communication system. If the vehicle 102 moves into the wireless connection possible range of the roadside machine 101, the in-vehicle device 104a mounted on the vehicle 102 establishes a Wi-Fi connection with the roadside machine 101 (F401). The in-vehicle device 104a extracts an information element such as an SSID of Wi-Fi communication (F402) and generates, from the information element, an L2ID to be used in Sidelink communication between vehicles (F403). Using the generated L2ID, the in-vehicle device 104a starts notifying information of the vehicle 102 and waiting for Sidelink communication from the in-vehicle device 104 of another vehicle (F404).

Similarly, if the vehicle 103 moves to the wireless connection possible range of the roadside machine 101, the in-vehicle device 104b mounted on the vehicle 103 establishes a Wi-Fi connection with the roadside machine 101 (F405). The in-vehicle device 104b extracts an information element such as an SSID of Wi-Fi communication (F406) and generates, from the information element, an L2ID to be used in Sidelink communication between vehicles (F407). Using the generated L2ID, the in-vehicle device 104b starts notifying information of the vehicle 103 and waiting for Sidelink communication from the in-vehicle device 104 of another vehicle (F408).

If the vehicle 102 and the vehicle 103 approach a Sidelink communication possible range, Sidelink connection is established (F409). Then, information exchange is executed between the vehicle 102 and the vehicle 103 as needed (F410). The contents of the information exchange are self-vehicle information generated by the vehicle information acquisition unit 306 or the video processing unit 308 and/or road traffic information indicating the presence/absence of an accident, congestion, an emergency vehicle, a construction working vehicle, and an abnormally traveling vehicle.

After that, if the vehicle 102 moves to the outside of the wireless communication range of the roadside machine 101, the in-vehicle device 104a detects disconnection of Wi-Fi (F411). Then, the in-vehicle device 104a ends the information notification of the vehicle 102 and waiting using the L2ID associated with the disconnected Wi-Fi (F412), and deletes the L2ID (F413).

Similarly, if the vehicle 103 moves to the outside of the wireless communication range of the roadside machine 101, the in-vehicle device 104b detects disconnection of Wi-Fi (F414). Then, the in-vehicle device 104b ends the information notification of the vehicle 103 and waiting using the L2ID associated with the disconnected Wi-Fi (F415), and deletes the L2ID (F416).

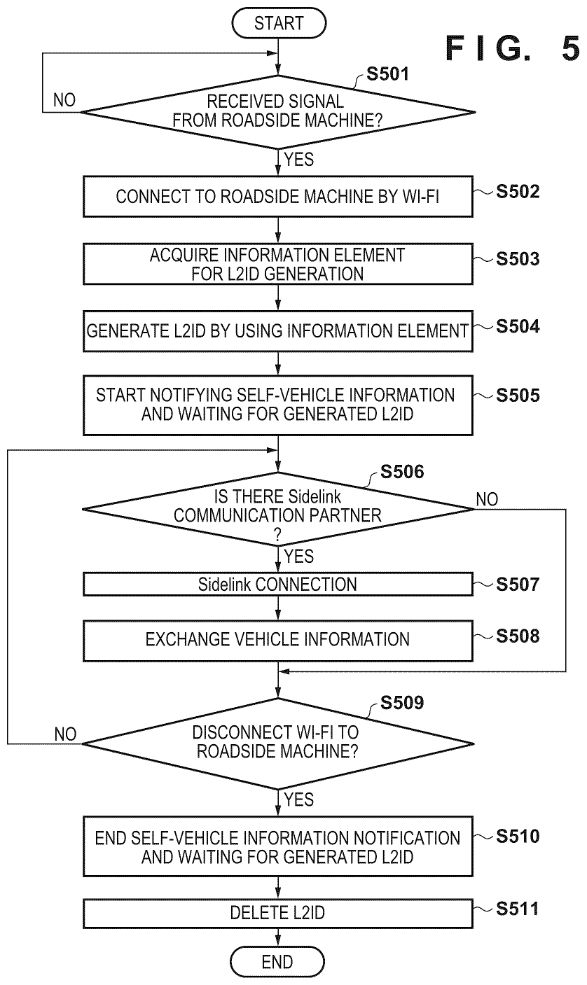

FIG. 5 is a flowchart for explaining processing in the in-vehicle device 104.

In step S501, the in-vehicle device 104 detects a Wi-Fi radio signal from the roadside machine by the wireless communication unit 305. For example, if the vehicle with the in-vehicle device 104 mounted enters the wireless connection possible range of the roadside machine 101, the radio signal is detected. If the radio signal is detected, the process advances to step S502.

In step S502, the in-vehicle device 104 is connected to the Wi-Fi network of the roadside machine via the wireless communication unit 305. In step S503, the in-vehicle device 104 acquires an SSID included in the signal from the connected Wi-Fi network and stores it as an information element in the storage unit 302.

In step S504, using a value generated by inputting the acquired SSID to a hash function or the like and information held by the in-vehicle device, the in-vehicle device 104 generates an L2ID necessary for transmission/reception of Sidelink communication by the communication identifier generation unit 307. More specifically, an L2ID to be used as a transmission source identifier and a reception destination identifier of Sidelink communication is generated.

In step S505, using the generated L2ID, the in-vehicle device 104 starts notifying self-vehicle information and waiting by the Sidelink communication unit 301.

In step S506, the in-vehicle device 104 determines whether a device serving as a partner of Sidelink communication is found. If a device is found, the process advances to step S507. If no device is found, the process advances to step S509.

In step S507, the in-vehicle device 104 establishes Sidelink connection with the found partner device. In step S508, the in-vehicle device 104 executes vehicle information exchange via the Sidelink communication with the partner device for which the Sidelink connection is established.

In step S509, the in-vehicle device 104 determines whether disconnection of Wi-Fi connection between the roadside machine 101 and the in-vehicle device 104 is detected. For example, if the vehicle with the in-vehicle device 104 mounted exits from the wireless connection possible range of the roadside machine 101, disconnection of Wi-Fi connection is detected. If disconnection is detected, the process advances to step S510. If disconnection is not detected, the process returns to step S506.

In step S510, the in-vehicle device 104 ends the self-vehicle information notification and waiting by the Sidelink communication unit 301 using the L2ID generated in step S504. After the end processing is completed, in step S511, the in-vehicle device 104 deletes the L2ID generated in step S504.

### Communication Method of Sidelink

The communication method of Sidelink will be described in more detail. As the Sidelink communication method, a “Broadcast communication method”, a “Groupcast communication method”, and a “Unicast communication method” exist.

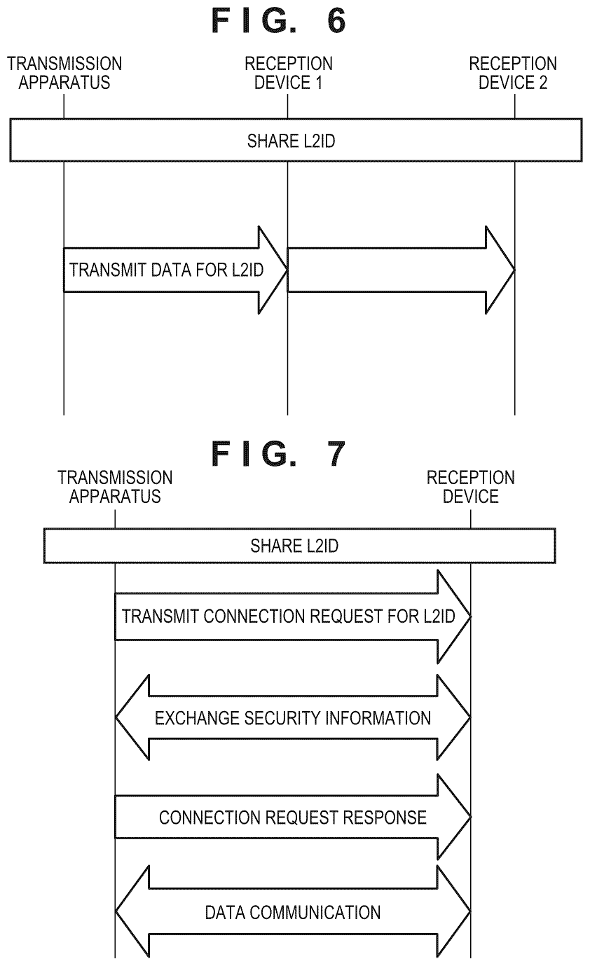

FIG. 6 is a view for explaining data transmission using an L2ID in the “Broadcast communication method” and the “Groupcast communication method”. As shown in FIG. 6, in the “Broadcast communication method” and the “Groupcast communication method”, a shared L2ID is set to a transmission destination and a reception destination in the devices on the transmitting and receiving sides, respectively. This setting enables data communication between the devices.

FIG. 7 is a view for explaining data transmission using an L2ID in the “Unicast communication method”. As shown in FIG. 7, in the “Unicast communication method”, a device on the transmitting side sends a connection request to a shared L2ID. A reception device having the shared L2ID exchanges security information and sends to a response to the connection request, thereby performing data communication.

In the processing examples shown in FIGS. 4 and 5, the description has been made assuming the “Groupcast communication method”, but any communication method can be applied.

As described above, the contents of communication between the in-vehicle device 104 and another in-vehicle device using Sidelink communication are the state or traveling schedule of the vehicle, a peripheral traffic situation detected by a sensor or a camera mounted on the vehicle, sensor data, and a camera video. For this reason, each vehicle can ascertain not only the presence/absence of an oncoming vehicle at a merging point but also information of an oncoming vehicle based on position information and speed information. For example, if information representing the state or traveling schedule of the vehicle is transmitted/received, driving support for the driver can be performed.

Also, in the Sidelink communication, since low-delay information exchange can be performed, order control in merging, braking control in case of emergency, and the like are also possible. In addition, road traffic information indicating an accident, congestion, an emergency vehicle, a construction working vehicle, or an abnormally traveling vehicle detected by another vehicle is received by the Sidelink communication and ascertained in advance, thereby enabling more safe traveling.

As described above, according to the first embodiment, the in-vehicle device 104 generates an L2ID based on the SSID of the roadside machine for which wireless communication is established. This makes it possible to share the L2ID between appropriate vehicles even in a place without a public line. Also, information exchange can be implemented between communication devices of an appropriate combination by generating an identifier in consideration of information receivable at that site and the contents of information exchange and using it in wireless communication.

According to the present invention, it is possible to provide a technique of facilitating information exchange between vehicles.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A communication device mounted on a moving body, comprising:
a first communication unit configured to receive a radio signal transmitted by a first wireless method;
a second communication unit configured to perform wireless communication by a second wireless method;
an obtaining unit configured to obtain an information element included in the radio signal received by the first communication unit;
a generation unit configured to generate, by using the information element, a communication identifier to be used in the wireless communication by the second wireless method;
a transmission unit configured to add the communication identifier to information concerning the moving body, and transmitting the information via the second communication unit; and
a reception unit configured to receive a radio signal from an external device, to which the communication identifier is added, via the second communication unit.

2. The communication device according to claim 1, wherein
the first wireless method is at least one of Wi-Fi, Bluetooth, ETC, cellular communication, and Sidelink communication, and
the second wireless method is Sidelink communication.

3. The communication device according to claim 1, wherein
the communication identifier is an L2ID (Layer-2 ID) in Sidelink communication.

4. The communication device according to claim 1, wherein the generation unit generates the communication identifier based on the information element included in the radio signal received by the first communication unit, and state information of the moving body.

5. The communication device according to claim 4, wherein
the information element is one of a network identifier and a transmission source address included in the radio signal transmitted by the first wireless method.

6. The communication device according to claim 1, wherein
the generation unit generates the communication identifier when communication via the first communication unit is established, and deletes the communication identifier when the communication via the first communication unit is disconnected.

7. The communication device according to claim 6, wherein
in a case where the communication via the first communication unit is disconnected, the generation unit ends transmission/reception by the transmission unit and the reception unit, and in a case where an end of the transmission/reception is completed, the generation unit deletes the communication identifier.

8. The communication device according to claim 1, wherein
the moving body is a vehicle traveling on a road, and
the radio signal transmitted by the first wireless method is a radio signal from a roadside machine installed on a side of the road.

9. A control method of a communication device mounted on a moving body, wherein
the communication device comprises:
a first communication unit configured to receive a radio signal transmitted by a first wireless method; and
a second communication unit configured to perform wireless communication by a second wireless method, and
the control method comprises:
obtaining an information element included in the radio signal received by the first communication unit;
generating, by using the information element, a communication identifier to be used in the wireless communication by the second wireless method;
adding the communication identifier to information concerning the moving body, and transmitting the information via the second communication unit; and
receiving a radio signal from an external device, to which the communication identifier is added, via the second communication unit.

10. A non-transitory computer-readable recording medium storing a program for causing a computer to execute a control method of a communication device mounted on a moving body, wherein
the communication device comprises:
a first communication unit configured to receive a radio signal transmitted by a first wireless method; and
a second communication unit configured to perform wireless communication by a second wireless method, and
the control method comprises:
obtaining an information element included in the radio signal received by the first communication unit;
generating, by using the information element, a communication identifier to be used in the wireless communication by the second wireless method;
adding the communication identifier to information concerning the moving body, and transmitting the information via the second communication unit; and
receiving a radio signal from an external device, to which the communication identifier is added, via the second communication unit.
